(19) United States
(12) Patent Application Publication
(10) Pub. No.: US 2014/0223541 A1
(43) Pub. Date: Aug. 7, 2014

(54) METHOD FOR PROVIDING SERVICE OF MOBILE VPN

(71) Applicant: ELECTRONICS & TELECOMMUNICATIONS RESEARCH INSTITUTE, Daejeon (KR)

(72) Inventors: Ho Sun YOON, Daejeon (KR); Sun Cheul KIM, Daejeon (KR); Ho Yong RYU, Daejeon (KR)

(73) Assignee: ELECTRONICS & TELECOMMUNICATIONS RESEARCH INSTITUTE, Daejeon (KR)

(21) Appl. No.: 14/083,872

(22) Filed: Nov. 19, 2013

(30) Foreign Application Priority Data
Feb. 4, 2013 (KR) 10-2013-0012171

(51) Int. Cl. H04L 29/06

(52) U.S. Cl. CPC H04L 63/0272
USPC 726/15

(57) ABSTRACT

Disclosed is a method for providing mobile virtual private network (VPN) services. An operation method of a group and tunnel manager (GTM) for providing mobile VPN services includes receiving a first message for registering information of a VPN group from a gateway, generating tunnel information between the GTM and the gateway based on the first message, and transmitting a packet based on the tunnel information. Accordingly, a private address may be used even in a mobile VPN, and therefore a VPN site may be configured even in an environment where a public address is difficult to use, or a flexible VPN site may be configured.

CLAIM FOR PRIORITY

This application claims priority to Korean Patent Application No. 10-2013-0012171 filed on Feb. 4, 2013 in the Korean Intellectual Property Office (KIPO), the entire contents of which are hereby incorporated by reference.

### BACKGROUND

1. Technical Field Example embodiments of the present invention relate in general to a method for providing mobile VPN services and more specifically to a method for providing mobile virtual private network (VPN) services which may use a private address as a destination address.

2. Related Art

Current virtual private network (VPN) technologies include a VPN technology using a security method such as Internet Protocol Security (IPSec) or Transport Layer Security (TLS) protocol, and a VPN technology using a tunneling method such as Multiprotocol Label Switching (MPLS). The VPN technology using the security method is commonly used for a VPN between a terminal and a site and between sites due to its superior security characteristics, and the VPN technology using the tunneling method is commonly used for supporting VPN connection between sites rather than security. In particular, the VPN technology using MPLS may use a private address, but supports only VPN services between sites. As a similar technology to the VPN technology, a Virtual Private Cloud (VPC) technology may support the private address while using the security method such as IPSec, but considers only connection between sites.

### SUMMARY

Accordingly, example embodiments of the present invention are provided to substantially obviate one or more problems due to limitations and disadvantages of the related art.

Example embodiments of the present invention provide a method for providing mobile virtual private network (VPN) services which may use a private address as a destination address and have mobility.

In some example embodiments, an operation method of a group and tunnel manager (GTM) for providing mobile virtual private network (VPN) services includes: receiving a first message for registering information of a VPN group from a gateway; generating tunnel information between the GTM and the gateway based on the first message; and transmitting a packet based on the tunnel information.

Here, at least one address included in an address set of the VPN group may be a private address.

In addition, the first message may include at least one of information about the gateway, a name of the VPN group of the gateway, and an address set of the VPN group.

In addition, the generating of the tunnel information may include allocating a VPN ID to the VPN group included in the first message, generating information of the VPN group including the VPN ID and generating a second message based on the information of the VPN group, transmitting the second message to the gateway having the VPN group and the gateway that has transmitted the first message, and generating the tunnel information between the GTM and the gateway.

In addition, the second message may include at least one of information about the GTM, an address of the gateway, the VPN ID of the VPN group, and information about an address set of the VPN group of the gateway.

In addition, the tunnel information may include at least one of the VPN ID, a destination address, an outer departure address, and an outer destination address, and the destination address is a private address.

In other example embodiments, an operation method of a gateway for providing mobile VPN services includes: transmitting a first message for registering information of a VPN group to a GTM; receiving, from the GTM, a second message generated based on the information of the VPN group including a VPN ID corresponding to the first message; generating tunnel information between the gateway and the GTM based on the second message; and transmitting a packet based on the tunnel information.

Here, at least one address included in an address set of the VPN group may be a private address.

Here, the first message may include at least one of information about the gateway, a name of the VPN group of the gateway, and address set information of the VPN group.

Here, the second message may include at least one of information about the GTM, an address of the gateway, the VPN ID of the VPN group, and information about an address set of the VPN group of the gateway.

Here, the tunnel information may include at least one of the VPN ID, a destination address, an outer departure address, and an outer destination address, and the destination address is a private address.

In still other example embodiments, an operation method of a mobile device for providing mobile VPN services includes: acquiring, from a GTM, information of a gateway having a VPN group desired to be connected; generating tunnel information between the mobile device and the gateway based on the acquired information of the gateway; and transmitting a packet based on the tunnel information.

Here, at least one address included in an address set of the VPN group may be a private address.

In addition, the acquiring of the information about the gateway may include transmitting, to the GTM, a gateway information request message for acquiring the information about the gateway having the VPN group desired to be connected, and receiving a gateway information response message corresponding to the gateway information request message.

In addition, the gateway information request message may include a name of the VPN group desired to be connected.

In addition, the gateway information response message may include at least one of a home address (HoA) of the mobile device, a care-of address (CoA) of the gateway having the VPN group desired to be connected, and address set information of the VPN group of the gateway.

In addition, the generating of the tunnel information may include transmitting a tunnel generation request message to the gateway, receiving, from the gateway, a tunnel generation response message corresponding to the tunnel generation request message, and generating the tunnel information between the mobile device and the gateway based on the tunnel generation response message.

In addition, the tunnel generation request message may include an address of the mobile device and a name of the VPN group desired to be connected.

In addition, the tunnel generation response message may include at least one of a CoA of the gateway having the VPN group desired to be connected, a VPN ID of the VPN group of the gateway, and address set information of the VPN group of the gateway.

In addition, the tunnel information may include at least one of the VPN ID, a destination address, an outer departure address, and an outer destination address, and the destination address is a private address.

### BRIEF DESCRIPTION OF DRAWINGS

Example embodiments of the present invention will become more apparent by describing in detail example embodiments of the present invention with reference to the accompanying drawings, in which:

FIG. 1 is a network configuration diagram illustrating a method for providing a mobile virtual private network (VPN) according to an embodiment of the present invention;

FIG. 2 is a diagram illustrating an operation procedure between a group and tunnel manager (GTM) and a first gateway in a method for providing mobile VPN services according to an embodiment of the present invention;

FIG. 3 is a diagram illustrating an operation procedure between GTM and two gateways in a method for providing mobile VPN services according to an embodiment of the present invention;

FIG. 4 is a diagram illustrating an operation procedure between a mobile device and a first gateway in a method for providing mobile VPN services according to an embodiment of the present invention;

FIG. 5 is a diagram illustrating an operation procedure between a mobile device and a second gateway in a method for providing mobile VPN services according to an embodiment of the present invention;

FIG. 6 is a diagram illustrating a configuration of a subscriber network of a second gateway in a method for providing mobile VPN services according to an embodiment of the present invention;

FIG. 7 is a diagram illustrating a packet transmission procedure between a mobile device and a second node in a method for providing mobile VPN services according to an embodiment of the present invention;

FIG. 8 is a diagram illustrating a packet transmission procedure between a first node and a second node in a method for providing mobile VPN services according to an embodiment of the present invention;

FIG. 9 is a flowchart illustrating an operation procedure of a GTM in a method for providing mobile VPN services according to an embodiment of the present invention;

FIG. 10 is a flowchart illustrating an operation procedure of a gateway in a method for providing mobile VPN services according to an embodiment of the present invention; and

FIG. 11 is a flowchart illustrating an operation procedure of a mobile device in a method for providing mobile VPN services according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

With reference to the appended drawings, exemplary embodiments of the present invention will be described in detail below. To aid in understanding the present invention, like numbers refer to like elements throughout the description of the figures, and the description of the same elements will be not reiterated.

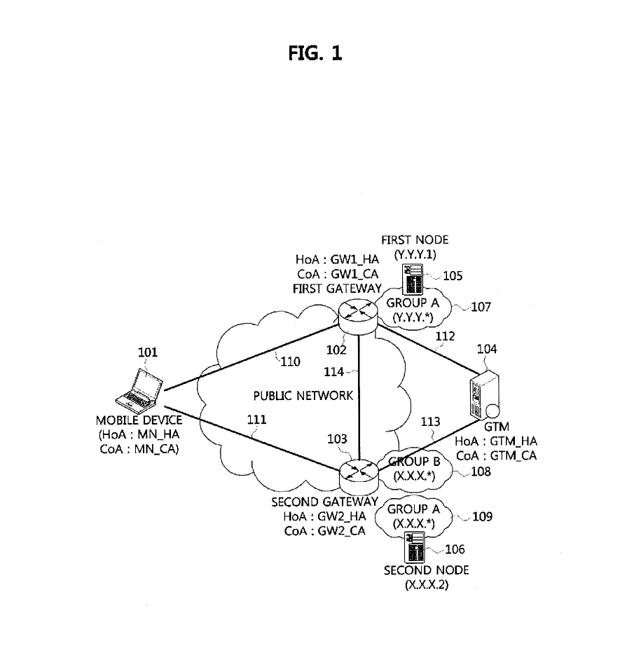

FIG. 1 is a network configuration diagram illustrating a method for providing a mobile virtual private network (VPN) according to an embodiment of the present invention.

Referring to FIG. 1, in a network configuration, a mobile device 101, a first gateway 102, a second gateway 103, a group and tunnel manager (GTM) 104, a first node 105, a second node 106, a first site 107 of a VPN group A, a first site 108 of a VPN group B, a second site 109 of the VPN group A, a mobile device 101, tunnels 110 and 111 between the mobile device 101 and the gateways 102 and 103, tunnels 112 and 113 between the GTM 104 and the gateways 102 and 103, and a tunnel 114 between the first gateway 102 and the second gateway 103 are provided.

The mobile device 101 is a mobile terminal that may support at least one wireless interface, and provide services in a heterogeneous network while moving.

The mobile device 101 may have a care-of Address (CoA) to be used in a public network and a home address (HoA) to be used as an ID for identifying a terminal.

The first gateway 102 may perform tunneling and security operations as a VPN gateway, and be assumed to have the VPN group A as a subscriber.

The second gateway 103 may perform tunneling and security operations as a VPN gateway, and be assumed to have the VPN group A and the VPN group B as a subscriber.

The GTM 104 may be management equipment for managing information of the VPN groups and performing packet transfer between the gateways, and perform a tunneling operation, if necessary.

The first node 105 may be in a network serviced by the first gateway 102 as one subscriber of the VPN group A, and be assumed to have a private address (Y.Y.Y.1) without including a VPN-related function.

The second node 106 may be in a network serviced by the second gateway 103 as one subscriber of the VPN group A, and be assumed to have a private address (X.X.X.2) without including the VPN-related function.

The first site 107 of the VPN group A uses a private address set (Y.Y.Y.*), and is managed by the first gateway 102.

The first site 108 of the VPN group B uses a private address set (X.X.X.*), and is managed by the second gateway 103.

The second site 109 of the VPN group A uses a private address set (X.X.X.*), and is managed by the second gateway 103.

The tunnel 110 between the mobile device 101 and the first gateway 102 refers to a tunnel between a mobile terminal and the first gateway 102, and uses a variety of tunnel methods, but will be described based on an IP-in-IP tunnel. Here, it is assumed that a CoA is used for an outer IP header, and an HoA is used for an inner IP header.

The tunnel 111 between the mobile device 101 and the gateway 103 refers to a tunnel between a mobile terminal and the second gateway 103.

The tunnel 112 between the GTM 104 and the first gateway 102 and the tunnel 113 between the GTM 104 and the second gateway 103 are tunnels for packets exchanged between gateways, and the packets exchanged between the gateways 102 and 103 are basically all exchanged through the GTM 104. However, when the tunnel is provided directly between the gateways 102 and 103, a corresponding tunnel is used, and in this case, the GTM 104 may not be used.

The tunnel 114 between the first gateway 102 and the second gateway 103 refers to a direct tunnel provided between the gateways, and in order to generate such a tunnel, a network address translation (NAT) traversal technology may be required. In the present invention, a specific procedure and method for generating the tunnel 114 between the first gateway 102 and the second gateway 103 will not be described.

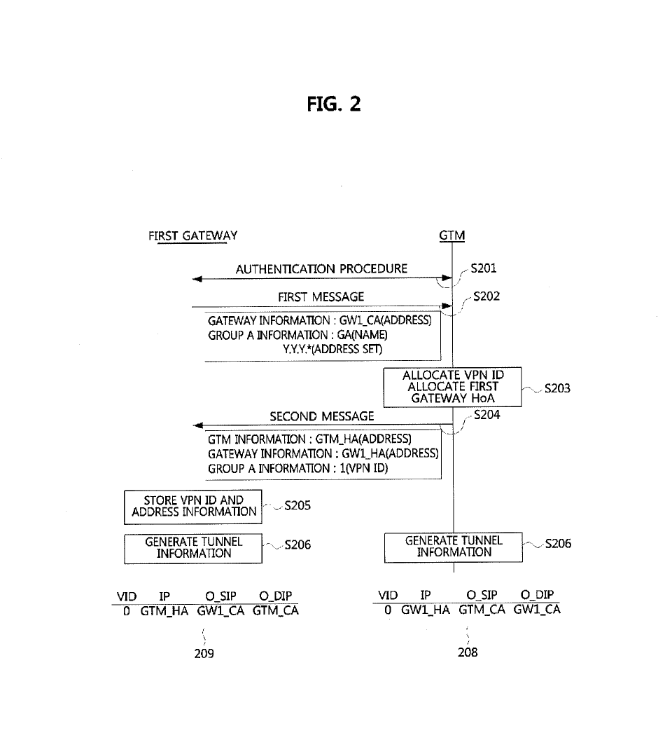

FIG. 2 is a diagram illustrating an operation procedure between GTM and a first gateway in a method for providing mobile VPN services according to an embodiment of the present invention.

In FIG. 2, VPN group information exchange between the GTM 104 and the first gateway 102 and a tunnel generating procedure are shown.

Referring to FIG. 2, in S201, the first gateway 102 and the GTM 104 may perform a mutual authentication procedure.

In such an authentication procedure, a variety of methods and techniques may be used, but in the present invention, specific methods and techniques will not be described.

In S202, the first gateway 102 may transmit, to the GTM, a first message for registering information of a VPN group including VPN information of a subscriber managed by the first gateway 102.

The first message transmitted by the first gateway 102 may include gateway address information (GW1_CA) for determining whether the first gateway 102 is positioned behind a NAT and information of the VPN group such as a VPN group name (GA) or an address set (Y.Y.Y.*)

In S203, the GTM 104 that has received the first message may allocate an ID (VPN ID) to a corresponding VPN group, and allocate an HoA to the first gateway 102.

Only one VPN ID may be defined for each VPN group, and used as an identifier for identifying the VPN group.

As for the HoA of the first gateway 102, only one HoA may be allocated for each gateway, and may be input directly by an operator in the first gateway 102.

In S204, the GTM 104 may transmit, to the first gateway 102, a second message generated based on the information of the VPN group including the VPN ID.

The second message transmitted by the GTM 104 may include at least one of an HoA of the GTM 104, an HoA of the first gateway 102, and a VPN ID of the VPN group A.

In S205, the first gateway 102 may store VPN ID information and address information which are included in the received second message.

In S206, the GTM 104 and the first gateway 102 may generate tunnel information between the GTM 104 and the first gateway 102 to thereby generate a tunnel.

First GTM tunnel information 208 refers to tunnel information generated by the GTM 104.

The tunnel information may include information of addresses to be utilized in an outer IP header using VID (VPN ID) and HoA.

For example, when the VPN ID is 0 and a destination address is GW1_HA of HoA of the first gateway 102, a new IP header may be created by inserting GTM_CA of CoA of the GTM 104 into a departure address (O_SIP) of the outer IP header, and inserting GW1_CA of CoA of the first gateway 102 into a destination address (O_DIP) of the outer IP header. First tunnel information 209 of the first gateway 102 refers to tunnel information generated in the first gateway 102. The tunnel information may be used for finding a departure address and a destination address of the outer IP header using VID (VPN ID) and HoA, and the addresses included in the outer IP header may use a CoA that can pass through a public network. In this instance, the VPN ID may be used as an identifier for identifying the VPN group, and a tunnel between the first gateway 102 and the GTM 104 is not associated with a private address, and therefore the tunnel may use a predetermined value that does not mean a specific VPN group.

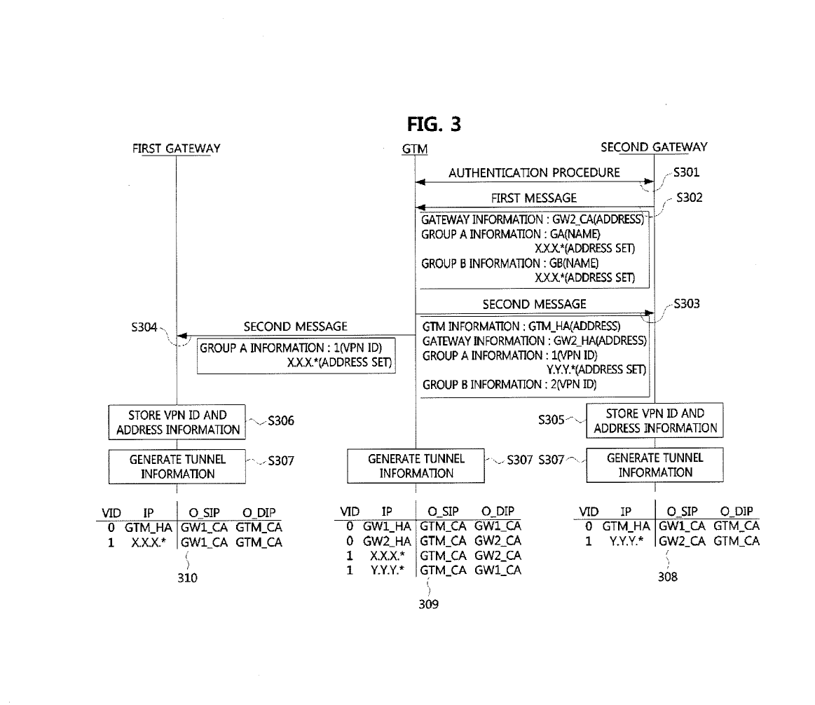

FIG. 3 is a diagram illustrating an operation procedure between GTM and two gateways in a method for providing mobile VPN services according to an embodiment of the present invention.

It is assumed that the operation procedure of FIG. 3 is performed after the procedure of FIG. 2 is completed, and in FIG. 3, a group information exchange procedure between the GTM 104 and two gateways 102 and 103 is shown.

In S301, the second gateway 103 and the GTM 104 may perform a mutual authentication procedure.

In the same manner as in FIG. 2, the authentication procedure between the GTM 104 and the second gateway 103 will not be specifically described in the present invention.

In S302, the second gateway 103 may transmit, to the GTM 104, a first message for registering information of a VPN group.

It is assumed that a corresponding first message includes information having the same type as in S202 of FIG. 2 and the second gateway 103 includes a VPN group A and a VPN group B, and therefore information of two VPN groups may be transmitted.

In S303, the GTM 104 that has received the first message from the second gateway 103 may transmit, to the second gateway 103, a second message generated based on the information of the VPN group.

The corresponding second message may include at least one of an HoA of the GTM 104, an HoA of the second gateway 103, VPN ID information of the VPN group A and the VPN group B, and VPN group A information included in the first gateway 102.

In S304, the GTM 104 that has received the first message from the second gateway 103 may transmit the second message to the first gateway 102.

The second message may include only address information of the VPN group A included in the second gateway 103, and does not include address information of the VPN group B. This is because a site included in the VPN group B is not in the first gateway 102. That is, the GTM 104 initially receives information associated with the VPN group A from the first gateway 102, and determines whether there is a gateway having the VPN group A.

When there is a gateway having the VPN group A, VPN group A information may be transmitted to the corresponding gateway, and when there is no gateway having the VPN group A, the VPN group A information may be transmitted only to the first gateway 102 (S204 of FIG. 2).

When the second gateway 103 transmits the first message to the GTM 104, the GTM 104 may search whether there is a gateway having information associated with the VPN group A and the VPN group B.

In the embodiment of the present invention, since the first gateway 102 has the VPN group A information, the GTM 104 may transmit corresponding information to the second gateway 103 in S303, and transmit VPN group A information registered by the second gateway 103 to the first gateway 102 in S304.

In S305, the second gateway 103 may store the VPN ID and address information which are included in the second message received from the GTM 104.

In S306, the first gateway 102 may store the VPN ID and address information which are included in the second message received from the GTM 104.

In S307, the first gateway 102, the GTM 104, and the second gateway 103 may generate tunnel information between the GTM 104 and the gateways 102 and 103 to thereby generate a tunnel.

First tunnel information 308 of the second gateway 103 includes tunnel information [VID(VPN ID): 0, IP: GTM_HA] with the GTM 104 and tunnel information [VID(VPN ID): 1, IP: Y.Y.Y.*] with the first gateway 102 including the VPN group A. In second GTM tunnel information 309 managed by the GTM 104, tunnel information of the second gateway 103 and two pieces of tunnel information (X.X.X.* and Y.Y.Y.*) associated with the VPN group A may be added to the first GTM tunnel information 208 of FIG. 2.

In second tunnel information 310 of the first gateway 102, tunnel information associated with an address set of X.X.X.* may be added to the first tunnel information 209 of the first gateway 102.

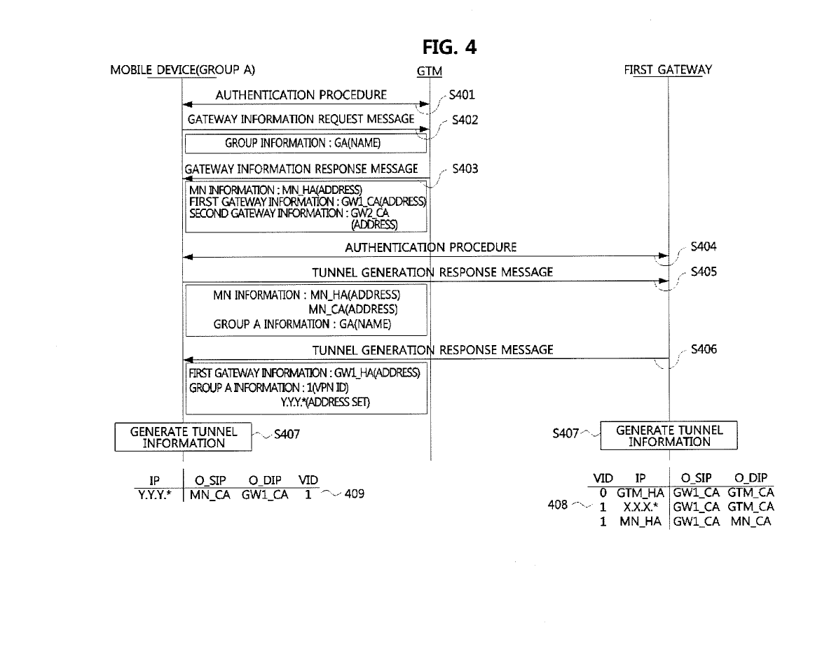

FIG. 4 is a diagram illustrating an operation procedure between a mobile device and a first gateway in a method for providing mobile VPN services according to an embodiment of the present invention.

In FIG. 4, it is assumed that the operation procedure of FIG. 4 is performed after the procedure of FIG. 3 is completed, and a tunnel setting procedure between the mobile device 101 included in the VPN group A and the first gateway 102 is shown.

In S401, the mobile device 101 and the GTM 104 may perform a mutual authentication procedure.

In S402, the mobile device 101 may transmit, to the GTM 104, a gateway information request message to acquire information about a gateway including a site associated with the VPN group A.

In S403, the GTM 104 may transmit, to the mobile device 101, a gateway information response message corresponding to the gateway information request message received from the mobile device 101.

The transmitted gateway information response message may include gateway information associated with the VPN group A and an HoA of the mobile device 101.

In S404, the mobile device 101 and the first gateway 102 may perform a mutual authentication procedure.

The authentication procedure with the first gateway 102 performed by the mobile device 101 may be based on the gateway information acquired in S403.

In S405, the mobile device 101 may transmit, to the first gateway 102, a tunnel generation request message to set a tunnel therebetween.

The setting of the tunnel with the first gateway 102 performed by the mobile device 101 may be based on the gateway information acquired in S403.

The tunnel generation request message in which the mobile device 101 requests tunnel setting from the first gateway 102 may include HoA and CoA information of the mobile device 101 for tunnel setting and a name of the VPN group A for representing the VPN group.

In S406, the first gateway 102 may transmit a tunnel generation response message including at least one of an HoA, a VPN ID, and an address set (Y.Y.Y.*) of the first gateway 102 for tunnel setting in response to the tunnel generation request message.

In S407, the first gateway 102 and the mobile device 101 may generate a mutual tunnel.

Here, in third tunnel information 408 of the first gateway 102, tunnel information [VID(VPN ID): 1, IP: MN_HA] with the mobile device 101 may be added to the second GTM tunnel information 309 of the first gateway 102.

First tunnel information 409 of the mobile device 101 may include tunnel information about a case in which a destination IP is Y.Y.Y.*, that is, a departure address (MN CA) and a destination address (GW1_CA) of an outer IP and a VID value (VPN ID) ‘1’.

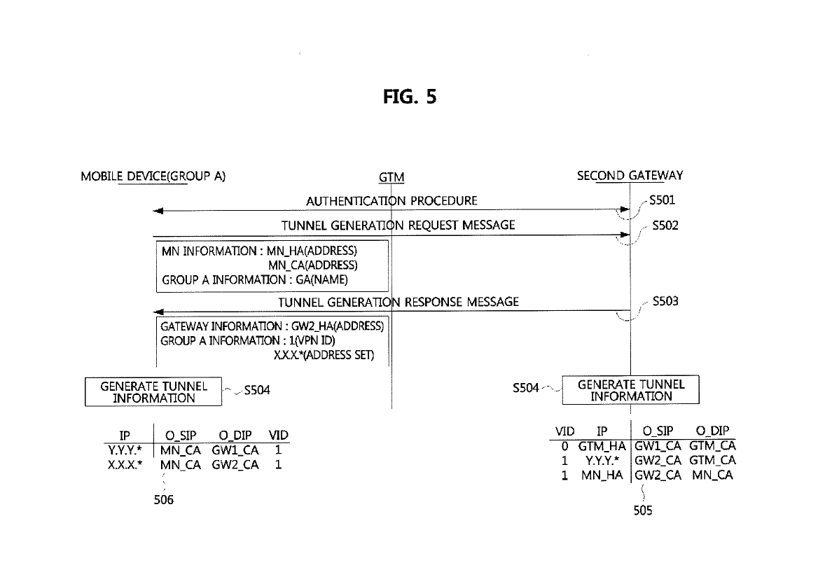

FIG. 5 is a diagram illustrating an operation procedure between a mobile device and a second gateway in a method for providing mobile VPN services according to an embodiment of the present invention.

In FIG. 5, it is assumed that the operation procedure of FIG. 5 is performed after the procedure of FIG. 4 is completed, and a tunnel setting procedure between the mobile device 101 and the second gateway 103 is shown.

In S501, the mobile device 101 and the second gateway 103 may perform an authentication procedure therebetween.

In S502, the mobile device 101 may transmit, to the second gateway 103, a tunnel generation request message including an HoA, a CoA, and group information of the mobile device 101.

In S503, the second gateway 103 may transmit, to the mobile device 101, the tunnel generation response message including at least one of an HoA, a VPN ID, and an address set (X.X.X.*) of the second gateway 103 in response to the request of the mobile device 101.

In S504, the mobile device 101 and the second gateway 103 may generate mutual tunnel information.

In second tunnel information 505 of the second gateway 103, information associated with the mobile device 101 may be added to the first tunnel information 308 of the second gateway 103.

In second tunnel information 506 of the mobile device 101, tunnel information about a case in which a destination IP is X.X.X.*, that is, departure address (MN_CA) and destination address (GW2_CA) of an outer IP, and a VID value (VPN ID) ‘1’ may be added to the first tunnel information 409 of the mobile device 101.

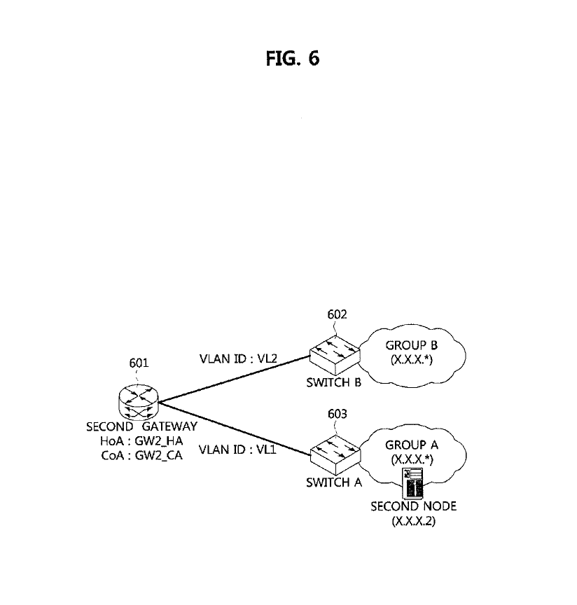

FIG. 6 is a diagram illustrating a configuration of a subscriber network of a second gateway in a method for providing mobile VPN services according to an embodiment of the present invention.

A switch B 602 for managing a second gateway 601 and a site of a VPN group B and a switch A 603 for managing a site of a VPN group A may be connected through a virtual local area network (VLAN).

Through the VLAN set between the switch B 602 for managing the site of the VPN group B and the second gateway 601 and the switch A 603 for managing the second gateway 601 and the site of the VPN group A, Ethernet frames with or without a VLAN ID may be exchanged.

When a VLAN ID is designated as “VL2” to an interface for the VPN group B in the second gateway 601, the second gateway 601 may map a VPN ID ‘2’ and a VLAN ID ‘VL2.’

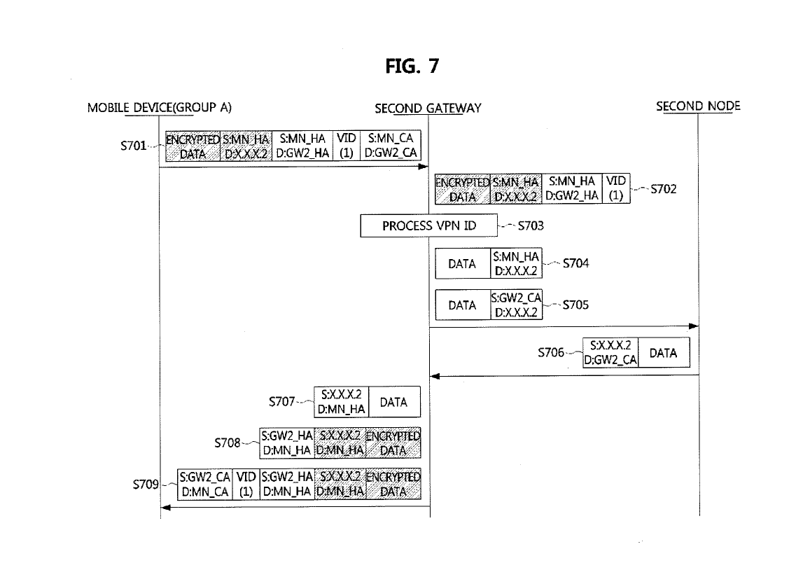

That is, when a frame is transmitted to the second gateway 601 from the VPN group B, the second gateway 601 may obtain a VPN ID ‘2’ using the VLAN ID ‘VL2.’ The VPN ID information may be used when controlling a packet in the future. FIG. 7 is a diagram illustrating a packet transmission procedure between a mobile device and a second node in a method for providing mobile VPN services according to an embodiment of the present invention.

It is assumed that the packet transmission procedure of FIG. 7 is performed after the procedure of FIG. 5 is completed.

In S701, the mobile device 101 included in the VPN group A may transmit a packet to the second gateway 103.

A departure address and a destination address of an outer IP header of the packet and a VID (VPN ID) may be obtained using tunnel information managed in the second tunnel information 506 of the mobile device 101 of FIG. 5. In addition, a center IP header (departure address: MN_HA and destination address: GW2_HA) and the innermost IP header (departure address: MN_HA and destination address: X.X.X.2) are IP headers used in an IPSec tunnel mode, and when the IPSec tunnel mode is not used, only the innermost IP header is needed.

In the mobile device 101, packet transmission to the second gateway 103 is performed using the outermost IP header.

In S702, the second gateway 103 may remove the outer IP used in the packet transmitted from the mobile device 101.

In S703, the second gateway 103 may obtain a corresponding VLAN ID value ‘VL1’ using a VID value (VPN ID) ‘1’ included in the packet transmitted from the mobile device 101, and obtain interface information to which the packet is to be transmitted using this information.

In S704, the second gateway 103 may decrypt a packet that has been encrypted in the IPSec tunnel mode which has been transmitted from the mobile device 101.

In S705, the second gateway 103 may transmit the packet to the second node by performing a NAT procedure with respect to the decrypted packet. When the NAT procedure is not performed, HoA information of the mobile device 101 should be routed in the second node 106.

In order to solve this problem, the departure address of the IP header may be changed into an address of the second gateway 103 to be transmitted to the second node 106.

In S706, in order to transmit the packet from the second node 106 to the mobile device 101, the packet whose destination address is the address of the second gateway 103 may be transmitted to the second gateway 103.

In S707, the second gateway 103 may generate a packet having an address of the mobile device 101 through the NAT procedure.

In S708, the second gateway 103 may perform encryption in the IPSec tunnel mode.

In S709, the second gateway 103 may add a VID (VPN ID), and add an IP required for a tunnel to transmit to the mobile device 101.

Corresponding VPN ID information may be obtained from VLAN ID information set between the switch A 603 and the second gateway 103 as described in FIG. 6, and outer IP header information may be obtained using second tunnel information 505 of the second gateway 103. In addition, the VPN ID information is not required in the mobile device 101, and thus can be omitted.

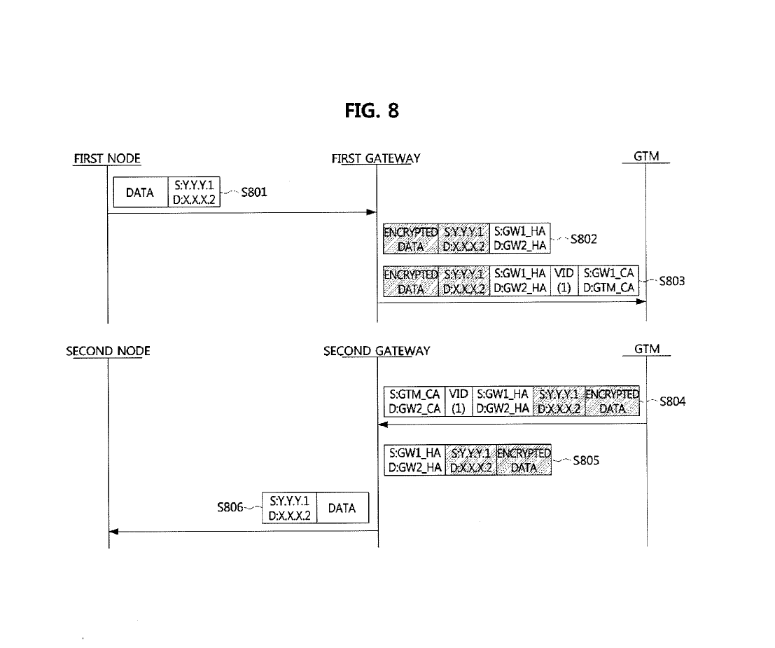

FIG. 8 is a diagram illustrating a packet transmission procedure between a first node and a second node in a method for providing mobile VPN services according to an embodiment of the present invention.

It is assumed that the procedure of FIG. 8 is performed after the procedure of FIG. 5 is completed.

In S801, a first node 105 may transmit a packet while setting a departure address as an address of the first node 105 and a destination IP as an address of a second node 106.

In this instance, when a VLAN ID is included in the packet transmitted to the first gateway 102, a VPN ID associated with a corresponding VLAN ID may be obtained, and when the VLAN ID is not included in the packet. a VLAN ID value may be obtained from the VLAN information allocated to a port that has received the packet, and a VPN ID value may be obtained using such a VLAN ID value.

In S802, the first gateway 102 may extract the VLAN ID, extract a VPN ID from the extracted VLAN ID, and perform an encryption procedure in the IPSec tunnel mode.

In S803, the first gateway 102 may generate a VID (VPN ID) and the outermost IP header using third tunnel information 408 of the first gateway 102.

In this instance, a destination IP is a CoA of the GTM in the outermost IP header, and therefore the packet may be transmitted to the GTM 104.

In S804, the GTM 104 that has received the packet may generate a packet using second GTM tunnel information 309.

That is, when the packet is received, the GTM 104 may remove the outermost IP header, and retrieve the second GTM tunnel information 309 using GW2_HA of a destination address of a center IP header and a VPN ID ‘0’ that does not mean a specific VPN group. Based on the retrieval results, a departure address of the outermost IP header is a CoA (GTM_CA) of the GTM 104 and a destination address thereof is a CoA (GW2_CA) of the second gateway 103.

The packet generated by the GTM 104 may be transmitted to the second gateway 103 through a public network.

In S805, the second gateway 103 may remove a part of the packet received from the GTM 104, which is used in the tunnel, and extract the VLAN ID.

The second gateway 103 may remove the outermost IP header and the VPN ID information, obtain the VLAN ID value from the VPN ID value ‘1’, and obtain interface information to which the packet is to be transmitted using the VLAN ID value.

In S806, the second gateway 103 may decrypt the data encrypted in the IPSec tunnel mode to transmit the packet to the second node 106.

The VPN ID included in the packet is not processed in a general IP layer, and is processed in a module for managing tunnel information and processing an actual packet. When a module for controlling a tunnel is implemented by software, a function of managing tunnel information and controlling a packet may be provided in a kernel, and when a corresponding module is implemented by hardware, the corresponding module may be included in a hardware module for processing an actual packet.

That is, the VPN ID does not have a general IP packet type, and therefore is required to be processed in a separate module.

In FIGS. 7 and 8, it has been assumed that data is encrypted in the IPSec mode. However, in order to perform data security using IPSec, it is necessary for Internet Key Exchange (IKE), which is a key exchange protocol, to support a private address.

A method in which IKE is operated in a private address environment is not discussed in the present invention. However, when the data security using the IPSec tunnel mode is not applied, the center IP header is not required, and as long as there are an outermost IP header and an innermost IP header, there is no strain on the entire operation.

In order to support a seamless handover between heterogeneous networks to mobile terminals having a variety of wireless interfaces, there is a variety of methods using IP-in-IP tunneling, and in the present invention, a specific method for providing a seamless handover between heterogeneous networks using the IP-in-IP tunneling will not be described.

In the present invention, a specific procedure and method that utilizes a VPN ID in order to use a private address is proposed, and in the embodiment, it is assumed that packet exchange between gateways is performed through a GTM.

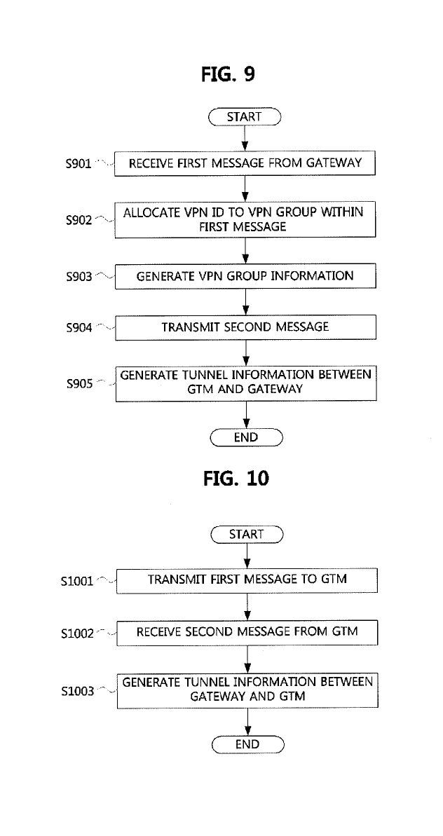

FIG. 9 is a flowchart illustrating an operation procedure of a GTM in a method for providing mobile VPN services according to an embodiment of the present invention.

Referring to FIG. 9, in S901, a GTM may receive, from a gateway, a first message for registering information of a VPN group.

The first message may include a gateway address, a name of a VPN group of the gateway, and address set information of the VPN group of the gateway, and an address of the VPN group may be a public address or a private address.

In S902, the GTM may allocate a VPN ID to the VPN group within the received first message.

In S903, the GTM may generate VPN group information including the VPN ID.

The VPN group information may include a VPN ID, a name of the VPN group, address set information of the VPN group, and the like.

The GTM may transmit, to the gateway to which the first message is transmitted, a second message including at least one of an HoA of the GTM, an HoA of the gateway, a VPN ID within the VPN group within the first message, and address set information of other gateways including the VPN group of the gateway, based on the VPN group information.

In addition, in S904, the GTM may transmit, to other gateways having the same VPN group, the second message including the VPN ID of the VPN group and the address set information of the VPN group of the gateway to which the first message is transmitted.

In S905, the GTM may generate tunnel information between gateways based on the VPN group information including the VPN ID.

Tunnel information between the GTM and the gateway may include a VPN ID, a destination address, an outer departure address, an outer destination address, and the like, and the destination address may be a private address.

FIG. 10 is a flowchart illustrating an operation procedure of a gateway in a method for providing mobile VPN services according to an embodiment of the present invention.

Referring to FIG. 10, in S1001, a gateway may transmit, to a GTM, a first message for registering information of a VPN group.

The first message may include a gateway address, a name of a VPN group of a gateway, and address set information of a VPN group of the gateway, and an address used in the VPN group may be a public address or a private address.

In S1002, the gateway may receive, from the GTM, a second message including information of a VPN group corresponding to the first message.

The second message may include at least one of an HoA of the GTM, an HoA of the gateway, a VPN ID of the VPN group within the first message, and address set information of other gateways including the VPN group of the gateway.

In S1003, the gateway may generate tunnel information between the gateway and the GTM based on the received second message to generate a tunnel.

The tunnel information between the gateway and the GTM may include a VPN ID, a destination address, an outer departure address, an outer destination address, and the like, and the destination address may be a private address.

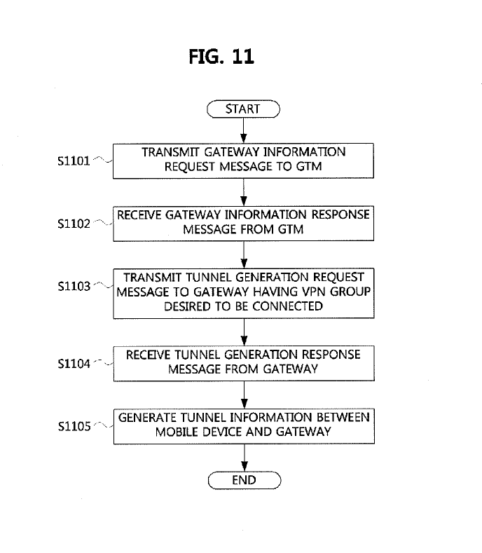

FIG. 11 is a flowchart illustrating an operation procedure of a mobile device in a method for providing mobile VPN services according to an embodiment of the present invention.

Referring to FIG. 11, in S1101, the mobile device may transmit, to a GTM, a gateway information request message so as to acquire information of a gateway having a VPN group desired to be connected.

In S1102, the mobile device may receive, from the GTM, a gateway information response message corresponding to the gateway information request message.

The gateway information response message may include a HoA of the mobile device, a CoA of the gateway having the VPN group desired to be connected, and address set information of the VPN group desired to be connected.

In S1103, the mobile device may transmit a tunnel generation request message to a corresponding gateway based on the gateway information response message.

The tunnel generation request message may include an HoA of the mobile device, a CoA of the mobile device, a name of the VPN group desired to be connected, and the like.

In S1104, the mobile device may receive, from the gateway, a tunnel generation response message corresponding to the tunnel generation request message.

The tunnel generation response message may include a CoA of a gateway, a VPN ID of the VPN group desired to be connected, VPN address set information, and the like.

In S1105, the mobile device may generate tunnel information between the mobile device and the gateway based on the tunnel generation response message to generate a tunnel.

The tunnel information between the mobile device and the gateway may include a VPN ID, a destination address, an outer departure address, an outer destination address, and the like, and the destination address may be a private address.

As described above, according to the embodiments of the present invention, in the method for providing the mobile VPN services, a private address may be used even in a mobile VPN providing mobility, thereby configuring a VPN site even in an environment where a public address is difficult to use, or configuring a flexible VPN site.

While the example embodiments of the present invention and their advantages have been described in detail, it should be understood that various changes, substitutions and alterations may be made herein without departing from the scope of the invention.

What is claimed is:

1. An operation method of group and tunnel manager (GTM) for providing mobile virtual private network (VPN) services, the operation method comprising:
receiving a first message for registering information of a VPN group from a gateway;
generating tunnel information between the GTM and the gateway based on the first message; and
transmitting a packet based on the tunnel information.

2. The operation method of claim 1, wherein at least one address included in an address set of the VPN group is a private address.

3. The operation method of claim 1, wherein the first message includes at least one of information about the gateway, a name of the VPN group of the gateway, and an address set of the VPN group.

4. The operation method of claim 1, wherein the generating of the tunnel information includes allocating a VPN ID to the VPN group included in the first message;
generating information of the VPN group including the VPN ID and generating a second message based on the information of the VPN group;
transmitting the second message to the gateway having the VPN group and the gateway that has transmitted the first message; and
generating the tunnel information between the GTM and the gateway.

5. The operation method of claim 4, wherein the second message includes at least one of information about the GTM, an address of the gateway, the VPN ID of the VPN group, and information about an address set of the VPN group of the gateway.

6. The operation method of claim 4, wherein the tunnel information includes at least one of the VPN ID, a destination address, an outer departure address, and an outer destination address, and the destination address is a private address.

7. An operation method of a gateway for providing mobile VPN(Virtual Private Network) services, the operation method comprising:
transmitting a first message for registering information of a VPN group to a GTM(Group and Tunnel Manager);
receiving, from the GTM, a second message generated based on the information of the VPN group including a VPN ID corresponding to the first message;
generating tunnel information between the gateway and the GTM based on the second message; and
transmitting a packet based on the tunnel information.

8. The operation method of claim 7, wherein at least one address included in an address set of the VPN group is a private address.

9. The operation method of claim 7, wherein the first message includes at least one of information about the gateway, a name of the VPN group of the gateway, and address set information of the VPN group.

10. The operation method of claim 7, wherein the second message includes at least one of information about the GTM, an address of the gateway, the VPN ID of the VPN group, and information about an address set of the VPN group of the gateway.

11. The operation method of claim 7, wherein the tunnel information includes at least one of the VPN ID, a destination address, an outer departure address, and an outer destination address, and the destination address is a private address.

12. An operation method of a mobile device for providing mobile VPN(Virtual Private Network) services, the operation method comprising:
acquiring, from a GTM(Group and Tunnel Manager), information of a gateway having a VPN group desired to be connected;
generating tunnel information between the mobile device and the gateway based on the acquired information of the gateway; and
transmitting a packet based on the tunnel information.

13. The operation method of claim 12, wherein at least one address included in an address set of the VPN group is a private address.

14. The operation method of claim 12, wherein the acquiring of the information about the gateway includes
transmitting, to the GTM, a gateway information request message for acquiring the information about the gateway having the VPN group desired to be connected; and
receiving a gateway information response message corresponding to the gateway information request message.

15. The operation method of claim 14, wherein the gateway information request message includes a name of the VPN group desired to be connected.

16. The operation method of claim 14, wherein the gateway information response message includes at least one of a home address (HoA) of the mobile device, a care-of address (CoA) of the gateway having the VPN group desired to be connected, and address set information of the VPN group of the gateway.

17. The operation method of claim 12, wherein the generating of the tunnel information includes
transmitting a tunnel generation request message to the gateway;
receiving, from the gateway, a tunnel generation response message corresponding to the tunnel generation request message; and
generating the tunnel information between the mobile device and the gateway based on the tunnel generation response message.

18. The operation method of claim 17, wherein the tunnel generation request message includes an address of the mobile device and a name of the VPN group desired to be connected.

19. The operation method of claim 17, wherein the tunnel generation response message includes at least one of a CoA(Care of Address) of the gateway having the VPN group desired to be connected, a VPN ID of the VPN group of the gateway, and address set information of the VPN group of the gateway.

20. The operation method of claim 17, wherein the tunnel information includes at least one of the VPN ID, a destination address, an outer departure address, and an outer destination address, and the destination address is a private address.
